(19) United States
(12) Patent Application Publication
(10) Pub. No.: US 2013/0088430 A1
(43) Pub. Date: Apr. 11, 2013

(54) ULTRA THIN LIGHT SCANNING APPARATUS FOR PORTABLE INFORMATION DEVICE

(71) Applicants: Sun Kyu Lee, Buk-gu (KR); Jae Young Joo, Buk-gu (KR); Cha Bum Lee, Buk-gu (KR); Do Kyun Woo, Buk-gu (KR)

(72) Inventors: Sun Kyu Lee, Buk-gu (KR); Jae Young Joo, Buk-gu (KR); Cha Bum Lee, Buk-gu (KR); Do Kyun Woo, Buk-gu (KR)

(73) Assignee: GWANGJU INSTITUTE OF SCIENCE AND TECHNOLOGY, Buk-gu, Gwangju (KR)

(21) Appl. No.: 13/703,725

(22) PCT Filed: Dec. 14, 2010
(86) PCT No.: PCT/KR2010/008919

§ 371 Date: Dec. 12, 2012

(30) Foreign Application Priority Data
Jun. 25, 2010 (KR) 10-2010-0060607

(51) Int. Cl. H04N 1/028; G06F 3/03

(52) U.S. Cl. CPC H04N 1/02815; G06F 3/0304
USPC 345/158; 358/475

(57) ABSTRACT

Disclosed is an ultra thin optical scanning device for a portable information device, which includes an LED as a light source and totally reflects light from an object-side surface to form an image, thereby increasing a contrast ratio of the image and improving the resolution thereof. The ultra thin optical scanning device includes a light emitting device that emits light for sensing an object, an object-side surface contacting the object and totally reflecting the light emitted from the light emitting device, an image formation part collecting the light totally reflected by the object-side surface, and transmitting the light, and a light receiver part forming an image by using the light transmitted by the image formation part.

### TECHNICAL FIELD

The present invention disclosed herein relates to an optical scanning device, and more particularly, to an ultra thin optical scanning device including a light emitting diode (LED) as a light source and totally reflecting light from an object-side surface to form an image, thereby increasing a contrast ratio of the image and improving the resolution thereof.

### BACKGROUND ART

Small information devices may receive information through a keypad and be controlled through the keypad. Input methods using a keypad are sufficient for limited and simple functions of typical information devices, such as input of a phone number or transmission of a text.

Recently developed optical scanning devices recognize a fingerprint or a bar code for improving user convenience and security. For example, a small pointing device using a finger skin is disclosed in Korean Patent Publication No. 10-2005-0002463. Light, emitted from a light emitting device, passes through a transparent plate through an incidence surface thereof and arrives at an object located on an opposite surface of the transparent plate to the incidence surface. Then, the light is reflected from the object. The light reflected from the object is transmitted to a light receiver part through a lens. As a result, the light receiver part recognizes an image of the object.

However, such typical optical scanning devices use an infrared LED and form an image using light absorbed and scattered by an object-side surface. Thus, a contrast ratio of an image formed at the light receiver part is low, which makes it difficult to obtain high resolution.

### DISCLOSURE

### Technical Problem

The present invention provides an optical scanning device and an optical pointing device including the optical scanning device, which uses total reflection to minimize the loss of light emitted from a light emitting device, thereby obtaining a high contrast ratio that improves the resolution of a scan image.

### Technical Solution

In accordance with an exemplary embodiment of the present invention, an ultra thin optical scanning device for a portable information device includes: a light emitting device that emits light for sensing an object; an object-side surface contacting the object and totally reflecting the light emitted from the light emitting device; an image formation part collecting the light totally reflected by the object-side surface, and transmitting the light; and a light receiver part forming an image by using the light transmitted by the image formation part.

The ultra thin optical scanning device may further include a condensing lens that collects the light emitted from the light emitting device, and emits the light in parallel to an optical axis. The condensing lens may be a Fresnel lens.

The ultra thin optical scanning device may further include an optical path changer part that guides a path of the light emitted from the light emitting device, to the object-side surface. The light guided to the object-side surface by the optical path changer part may form an incidence angle such that the light is totally reflected from the object-side surface. The object-side surface, the image formation part, and the optical path changer part may be integrally formed with a main body.

The light emitting device may be a light emitting diode (LED), particularly, a blue LED.

The ultra thin optical scanning device may further include a re-reflection surface that totally reflects the light totally reflected by the object-side surface, to the image formation part. The object-side surface, the image formation part, and the re-reflection surface may be integrally formed with a main body.

The image formation part may be a Fresnel lens or an array lens.

An assembly guide may be disposed in a side portion of the main body.

In accordance with another exemplary embodiment of the present invention, an ultra thin optical pointing device for a portable information device includes: a light emitting device that emits light for sensing an object; an object-side surface contacting the object and totally reflecting the light emitted from the light emitting device; an image formation part collecting the light totally reflected by the object-side surface, and transmitting the light; a light receiver part forming an image by using the light transmitted by the image formation part; a calculation part detecting a movement of the object by using the image, to calculate a coordinate value; and a display part displaying a pointer according to the calculated coordinate value.

The ultra thin optical pointing device may further include a condensing lens that collects the light emitted from the light emitting device, and emits the light in parallel to an optical axis.

The ultra thin optical pointing device may further include an optical path changer part that guides a path of the light emitted from the light emitting device, to the object-side surface. The object-side surface, the image formation part, and the optical path changer part may be integrally formed with a main body.

The ultra thin optical pointing device may further include a re-reflection surface that totally reflects the light totally reflected by the object-side surface, to the image formation part. The object-side surface, the image formation part, and the re-reflection surface may be integrally formed with a main body.

### Advantageous Effects

According to the present invention, since light emitted from a light emitting device is totally reflected from an object-side surface, the loss of the light is minimized. Thus, even when the light emitting device has a small capacity, a large area can be sufficiently scanned.

In addition, light refracted and scattered by the object-side surface is not used to form an image, and only totally reflected light is used to form an image. Thus, an image formed according to the present invention has a higher contrast ratio and higher resolution than those of an image formed in the prior art.

In addition, an optical path changer part, the object-side surface, a re-reflection surface, and an image formation part are integrally formed with a main body, and a guide recess is formed in the main body. Thus, an assembly tolerance that may occur during an assembly process can be decreased, and work efficiency can be improved.

In addition, since the image formation part includes an array lens, the image formation part has a short focal length and copes with a large scan region, which makes it possible to miniaturize an optical scanning device.

### DESCRIPTION OF DRAWINGS

FIG. 1 is a schematic view illustrating a configuration of an optical scanning device according to an embodiment of the present invention.

FIG. 2 is an enlarged view illustrating a portion A of FIG. 1.

FIG. 3 is an enlarged view illustrating a portion B of FIG. 1.

FIG. 4 is a schematic view illustrating a case that an image is formed on a light receiver part of an optical scanning device according to another embodiment of the present invention.

FIGS. 5A and 5B are images illustrating an object scanned by an optical scanning device and a scan image thereof, according to the present invention.

FIG. 6 is a schematic view illustrating a configuration of an optical pointing device including an optical scanning device according to the present invention.

### BEST MODE

Preferred embodiments of the present invention will be described below in detail with reference to the accompanying drawings. In the following description and attached drawings, like elements are substantially denoted by like reference numerals, even in the case that they are illustrated in different drawings. Moreover, detailed descriptions related to well-known functions or configurations will be ruled out in order not to unnecessarily obscure subject matters of the present invention.

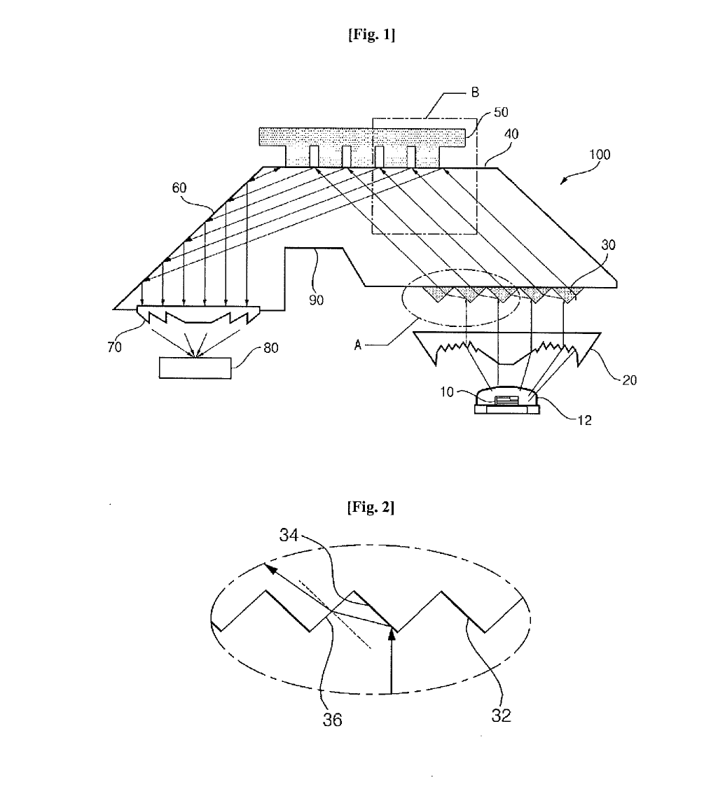

FIG. 1 is a schematic view illustrating a configuration of an optical scanning device according to an embodiment of the present invention. FIG. 2 is an enlarged view illustrating a portion A of FIG. 1. FIG. 3 is an enlarged view illustrating a portion B of FIG. 1.

Referring to FIG. 1, an optical scanning device according to the current embodiment may include: a light emitting device 10 that emits light to sense an object 50; a condensing lens 20 that collects the light emitted from the light emitting device 10 and emits the light in parallel to an optical axis of the light emitting device 10; an optical path changer part 30; an object-side surface 40; a re-reflection surface 60; an image formation part 70; and a light receiver part 80 including a plurality of pixels that form an image by using light transmitted through the image formation part 70 and a main body 100 integrally formed with an assembly guide 90.

The main body 100 may include: the optical path changer part 30 guiding the path of light emitted from the light emitting device 10, to the object-side surface 40; the object-side surface 40 contacting the object 50 and totally reflecting the light emitted from the light emitting device 10; the re-reflection surface 60 totally re-reflecting the light totally reflected from the object-side surface 40, to the image formation part 70; the image formation part 70 collecting the light totally reflected from the object-side surface 40, and transmitting the light; and the assembly guide 90 guiding an assembly position of the main body 100.

The light emitting device 10 is a component that emits light for sensing the object 50. A device such as a light emitting diode (LED) chip may be used as the light emitting device 10, and a blue LED may be used in the current embodiment. A blue LED has high brightness and thus can effectively have a high contrast ratio. An LED may be used in a package form. An LED package may include: a mounting substrate on which an LED chip is placed; and an encapsulant 12 for protecting the LED chip from the outside. The encapsulant 12 may be an insulating resin having high light transmittance, including epoxy or silicone. A fluorescent substance and/or a dispersing agent may be included in the encapsulant 12.

The condensing lens 20 is disposed on the optical axis of the light emitting device 10 to collect light emitted from the light emitting device 10 and emit the light in parallel to the optical axis of the light emitting device 10. Since a typical LED has an orientation angle of about 45° or greater, a light collection efficiency for a typical LED is decreased. Thus, the condensing lens 20 such as a Fresnel lens collects a light flux scattered from an LED, in one direction, thereby improving the light collection efficiency for the LED.

The Fresnel lens used as the condensing lens 20 has a plurality of concentric Fresnel patterns. The concentric Fresnel patterns are designed to have a saw-toothed cross section. Thus, light is incident to the concentric Fresnel patterns and is totally reflected, whereby an orientation angle thereof is adjusted. The concentric Fresnel patterns are also designed such that after light emitted from the light emitting device 10 is incident to the concentric Fresnel patterns and is totally reflected, the light is emitted in parallel to the optical axis.

The main body 100 may be formed of a light transmitting material. The optical path changer part 30, the object-side surface 40, the re-reflection surface 60, the image formation part 70, and the assembly guide 90 may be integrally formed with corresponding portions of the main body 100. The main body 100 may be formed of poly methyl methacrylate (PMMA), but is not limited thereto. Thus, a material used to form the main body 100 may be selected from various optical polymers. Light emitted from the light emitting device 10 may be incident into the main body 100 through the optical path changer part 30, and be emitted from the image formation part 70 via the object-side surface 40 and the re-reflection surface 60.

The optical path changer part 30 changes a propagation path of light emitted from the light emitting device 10, toward the object-side surface 40. Accordingly, an incident angle equal to or greater than a critical angle is formed between the propagation path and the object-side surface 40, so that the light can be totally reflected from the object-side surface 40. Thus, light is totally reflected from the object-side surface 40, to thereby form an image. To this end, light emitted from the light emitting device 10 should be incident to the object-side surface 40 at an angle such that the light is totally reflected from the object-side surface 40. That is, light should be incident to the object-side surface 40 at the critical angle or greater. Thus, the path of light emitted from the light emitting device 10 is changed by the optical path changer part 30 and is incident to the object-side surface 40 at the critical angle or greater.

Referring to FIG. 2, the optical path changer part 30 includes: reflective surfaces 34 on which a reflective coating layer 32 is formed; and refractive surfaces 36 having no reflective coating layer. The reflective coating layer 32 may be formed by depositing a metal such as aluminum. Since the reflective coating layer 32 is formed on the optical path changer part 30, light emitted from the light emitting device 10 is reflected from the reflective surface 34. Since the reflective coating layer 32 is not formed on the refractive surface 36, the light emitted from the light emitting device 10 is not reflected from the refractive surface 36 and is transmitted thereby. That is, light emitted from the light emitting device 10 rectilinearly propagates and is reflected from the reflective surface 34 at a reflection angle equal to an incidence angle. Then, the light rectilinearly propagates again in a reflection direction and is refracted at a predetermined angle by the refractive surface 36. Then, the light arrives at the object-side surface 40. At this point, an incidence angle of the light is equal to or greater than the critical angle that satisfies a total reflection condition. The critical angle is determined according to a relation between the refractivity of air and the refractivity of a material used to form the object-side surface 40. The reflective surfaces 34 and refractive surfaces 36 of the optical path changer part 30 may be designed such that the incidence angle of light to the object-side surface 40 is equal to or greater than the critical angle. Light that is not reflected from the reflective surface 34 may be directly incident to the refractive surface 36 of the optical path changer part 30 on which the reflective coating layer 32 is not formed. In this case, the light is refracted only, and thus is incident to the object-side surface 40 at the critical angle or smaller. Accordingly, the light is not totally reflected from the object-side surface 40.

The object-side surface 40 contacts the object 50, and light emitted from the light emitting device 10 is totally reflected or refracted by the object-side surface 40. Referring to FIG. 3, when the object 50 contacting the object-side surface 40 has an uneven surface, the object-side surface 40 is divided into a contact region 42 contacting the object 50 and a non-contact region 44 that does not contact the object 50. A light ray 94 emitted from the light emitting device 10 is totally reflected from the non-contact region 44 and propagates. However, a portion of a light ray 92 arriving at the contact region 42 is absorbed by the object 50 and the other is scattered and reflected. That is, light arriving at the non-contact region 44 is totally reflected and propagates to the image formation part 70, and light arriving at the contact region 42 is absorbed, refracted, or scattered and thus does not propagate to the image formation part 70. This is because light is totally reflected from a region of the object-side surface 40 which does not contact the object 50 and contacts an air layer having smaller refractivity than that of the object-side surface 40, and light is not totally reflected from a region of the object-side surface 40 which contacts the object 50 and has greater refractivity than that of the object-side surface 40.

The light, totally reflected from the object-side surface 40, is totally reflected to the image formation part 70 by the re-reflection surface 60. The re-reflection surface 60 may be removed if necessary. In this case, the light totally reflected from the object-side surface 40 directly propagates to the image formation part 70.

The image formation part 70 collects the light totally reflected from the object-side surface 40 and transmits the light to the light receiver part 80, and a lens having a short focal length may be used as the image formation part 70 to miniaturize the optical scanning device. The image formation part 70 may include an array lens to correspond to the size of a scan image, and the array lens may have a matrix structure.

The image formation part 70 may be any one of a spherical Fresnel lens, an aspheric Fresnel lens, a spherical lens, and an aspheric lens. In particular, since a lens used as the image formation part 70 has a short focal length to miniaturize the optical scanning device, the lens may be a flat lens such as a hybrid diffraction lens and a multi level lens.

The light receiver part 80 may be an image capturing device that receives, through the image formation part 70, light totally reflected from the object-side surface 40, to thereby form an image, and may include a complementary metal oxide semiconductor (CMOS) or charge coupled device (CCD) having a plurality of pixels. Since the light receiver part 80, forming an image by using the light totally reflected two times by the object-side surface 40 and the re-reflection surface 60, is inclined from the re-reflection surface 60, a small image sensor can cope with a large scan region. Although a scan region of the object-side surface 40 has a length of 2.8 mm, the main body 100 has a thickness of 1.5 mm, and the light receiver part 80 has a length of 0.9 mm, thereby miniaturizing the optical scanning device.

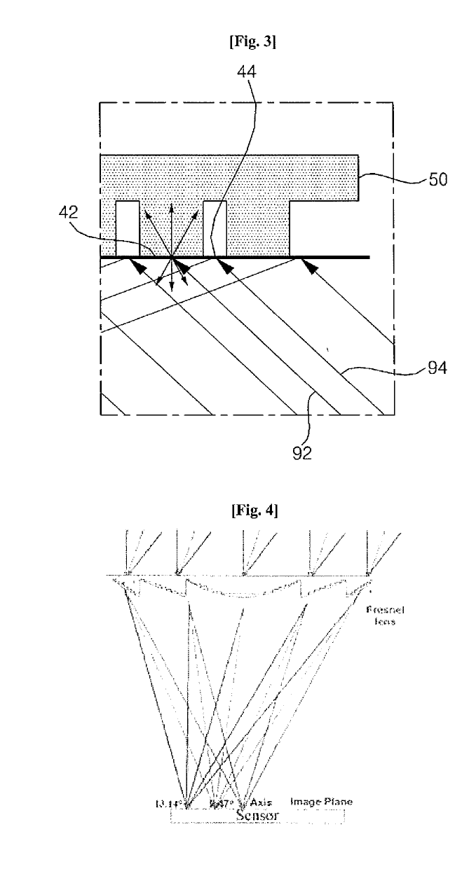

In practice, the light totally reflected from the object-side surface 40 and incident to the image formation part 70 may be divided into light perpendicularly incident to the image formation part 70 and light obliquely incident thereto. However, as illustrated in FIG. 4 showing a case that an image is formed on a light receiver part of an optical scanning device according to the present invention, a deviation of incidence angles of the light incident to the image formation part 70 is within ±15 degrees with respect to an optical axis thereof. Thus, the resolution of an image formed on the light receiver part 80 is significantly higher than that of an image formed by a typical light scanning device.

The assembly guide 90 may have a recess shape corresponding to the shape of a guide protrusion that may be formed on a substrate, so that the main body 100 can be efficiently coupled to the substrate. The optical path changer part 30, the object-side surface 40, the re-reflection surface 60, and the image formation part 70 may be integrally formed with the main body 100, whereas the light emitting device 10, the condensing lens 20, and the light receiver part 80 may be separately formed from the main body 100. When the light emitting device 10 is separately formed from the main body 100, the light emitting device 10, the condensing lens 20, the optical path changer part 30, the image formation part 70, and the light receiver part 80 should be aligned with one another. To simplify the aligning and improving the accuracy thereof, the condensing lens 20 is located in an appropriate position on a substrate having a guide protrusion, and then, the main body 100 is coupled to the substrate to insert the guide protrusion into the recess of the main body 100.

Scattered and reflected light without being totally reflected from the object-side surface 40 may negatively affect a formation of an image of the object 50. In this case, the assembly guide 90 functions as a barrier for preventing such scattered and reflected light from being incident to the image formation part 70. Light scattered and reflected by regions of the object-side surface 40 which do not contact the object 50 is prevented from being incident to the image formation part 70 by the assembly guide 90, thereby improving the resolution of an image of the object 50 formed on the light receiver part 80.

Hereinafter, an operation of the optical scanning device will now be described with reference to the above-described components.

Light emitted from the light emitting device 10 is collected by the condensing lens 20 and propagates in parallel to the optical axis of the light emitting device 10. Then, the light is reflected and refracted by the optical path changer part 30 and the path thereof is changed. Accordingly, the light is incident to the object-side surface 40 at the critical angle or greater. Among the incident light, light incident to the contact region 42 contacting the object 50 is absorbed and scattered, and light incident to the non-contact region 44 is totally reflected and propagates. The light ray 94 totally reflected from the object-side surface 40 is totally reflected again to the image formation part 70 by the re-reflection surface 60, and the image formation part 70 transmits the light ray 94 to the light receiver part 80 to form an image thereon.

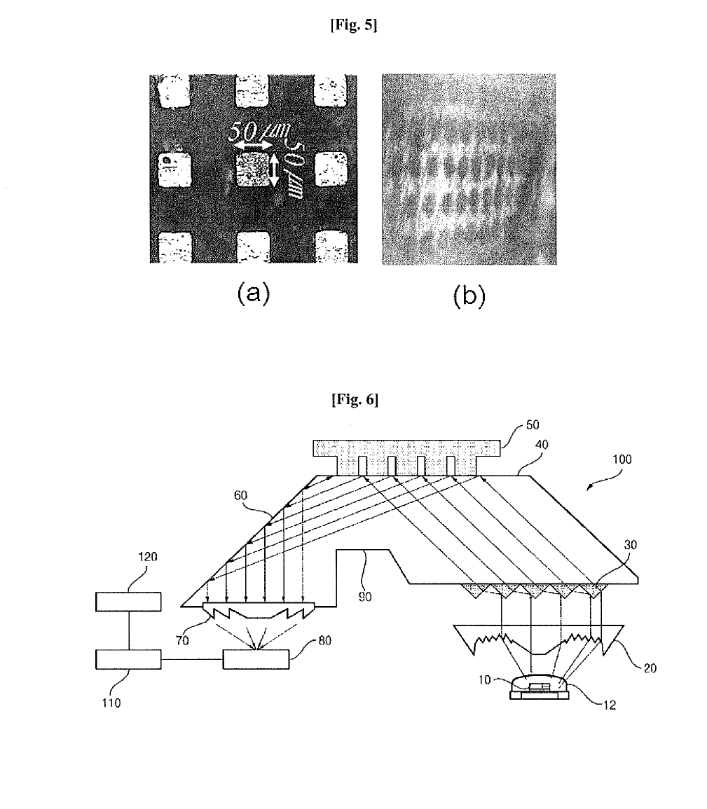

As a result, the light totally reflected from the object-side surface 40 is used to form the image on the light receiver part 80. Since the total reflection from the object-side surface 40 occurs on the non-contact region 44, the light incident to the light receiver part 80 includes information about regions of the object 50 which do not contact the object-side surface 40. That is, referring to FIGS. 5A and 5B, a region of the object-side surface 40 contacting air instead of the object 50 is sensed as a bright region by the light receiver part 80, and a region of the object-side surface 40 contacting the object 50 such as a human skin is sensed as a dark region by the light receiver part 80 since light is not totally reflected from the region of the object-side surface 40. Thus, the region of the object-side surface 40 contacting the object 50 is expressed as a reversal image in the image of the object 50.

The light ray 92 that is refracted and scattered by the object-side surface 40 is not employed to form an image, and the light ray 94 that is totally reflected by the object-side surface 40 is employed to form an image. According to the current embodiment, since total reflection is used instead of typical scattered reflection, the loss of light emitted from the light emitting device 10 is minimized, thereby obtaining a high contrast ratio that improves the resolution of a scan image. Furthermore, when a blue LED is used as the light emitting device 10, the high contrast ratio can be maximized.

When the object 50 is a finger, a finger can be scanned to form a fingerprint. When the object 50 is a micro bar code, the micro bar code can be scanned. However, the application of the optical scanning device is not limited thereto, and thus, the optical scanning device may be applied to various devices such as an optical pointing device.

In particular, the optical scanning device may be applied to an optical pointing device by linking the optical scanning device to a display device. Referring to FIG. 6, an optical pointing device including the optical scanning device may further include: a calculation part 110 that detects a movement of an object by using an image formed at the light receiver part, to calculate a coordinate value; and a display part 120, that is, a display device, which displays a pointer according to the calculated coordinate value. Under the above configuration, when a finger of a user is moved on the object-side surface, the calculation part 110 calculates, based on information about an image formed at the light receiver part, a moving direction of the finger, a moving speed of the finger, and whether the finger is moved, so as to determine coordinate value. The display part 120 connected to the calculation part 110 displays the pointer on a screen according to the movement of the finger, based on the coordinate value. Since an optical scanning device according to the present invention is smaller and slimmer than a typical optical scanning device, an optical scanning device according to the present invention is suitable for a miniaturized mobile communication terminal such as a smart phone, and a game terminal.

Until now, preferred embodiments of the present invention are described mainly. It will be understood by those skilled in the art that various modifications, changes, and replacements may be made therein without departing from the spirit and scope of the invention. Thus, the preferred embodiments should be considered in descriptive sense only and not for purposes of limitation. The scope of the invention is defined not by the detailed description of the invention but by the appended claims, and all differences within the scope will be construed as being included in the present invention.

1. An ultra thin optical scanning device for a portable information device, comprising:
a light emitting device that emits light for sensing an object;
an object-side surface contacting the object and totally reflecting the light emitted from the light emitting device;
an image formation part collecting the light totally reflected by the object-side surface, and transmitting the light; and
a light receiver part forming an image by using the light transmitted by the image formation part.

2. The ultra thin optical scanning device of claim 1, further comprising a condensing lens that collects the light emitted from the light emitting device, and emits the light in parallel to an optical axis.

3. The ultra thin optical scanning device of claim 2, wherein the condensing lens is a Fresnel lens.

4. The ultra thin optical scanning device of claim 1, further comprising an optical path changer part that guides a path of the light emitted from the light emitting device, to the object-side surface.

5. The ultra thin optical scanning device of claim 4, wherein the light guided to the object-side surface by the optical path changer part forms an incidence angle such that the light is totally reflected from the object-side surface.

6. The ultra thin optical scanning device of claim 1, wherein the light emitting device is a light emitting diode (LED).

7. The ultra thin optical scanning device of claim 6, wherein the LED is a blue LED.

8. The ultra thin optical scanning device of claim 1, further comprising a re-reflection surface that totally reflects the light totally reflected by the object-side surface, to the image formation part.

9. The ultra thin optical scanning device of claim 1, wherein the image formation part is a Fresnel lens.

10. The ultra thin optical scanning device of claim 1, wherein the image formation part is an array lens.

11. The ultra thin optical scanning device of claim 4, wherein the object-side surface, the image formation part, and the optical path changer part are integrally formed with a main body.

12. The ultra thin optical scanning device of claim 8, wherein the object-side surface, the image formation part, and the re-reflection surface are integrally formed with a main body.

13. The ultra thin optical scanning device of claim 11, wherein an assembly guide is disposed in a side portion of the main body.

14. An ultra thin optical pointing device for a portable information device, comprising:
a light emitting device that emits light for sensing an object;
an object-side surface contacting the object and totally reflecting the light emitted from the light emitting device;
an image formation part collecting the light totally reflected by the object-side surface, and transmitting the light;
a light receiver part forming an image by using the light transmitted by the image formation part;
a calculation part detecting a movement of the object by using the image, to calculate a coordinate value; and
a display part displaying a pointer according to the calculated coordinate value.

15. The ultra thin optical pointing device of claim 14, further comprising a condensing lens that collects the light emitted from the light emitting device, and emits the light in parallel to an optical axis.

16. The ultra thin optical pointing device of claim 14, further comprising an optical path changer part that guides a path of the light emitted from the light emitting device, to the object-side surface.

17. The ultra thin optical pointing device of claim 14, further comprising a re-reflection surface that totally reflects the light totally reflected by the object-side surface, to the image formation part.

18. The ultra thin optical pointing device of claim 16, wherein the object-side surface, the image formation part, and the optical path changer part are integrally formed with a main body.

19. The ultra thin optical pointing device of claim 17, wherein the object-side surface, the image formation part, and the re-reflection surface are integrally formed with a main body.

20. The ultra thin optical scanning device of claim 12, wherein an assembly guide is disposed in a side portion of the main body.
